(19) United States
(12) Patent Application Publication
(10) Pub. No.: US 2021/0354830 A1
(43) Pub. Date: Nov. 18, 2021

(54) TRAVEL PRIVACY & PROTECTIVE CURTAIN

(71) Applicant: Michael Straub, San Jose, CA (US)

(72) Inventor: Michael Straub, San Jose, CA (US)

(21) Appl. No.: 15/930,163

(22) Filed: May 12, 2020

(51) Int. Cl. B64D 11/00; B64D 11/06

(52) U.S. Cl. CPC B64D 11/0023; B64D 11/0606

(57) ABSTRACT

A personal privacy and protective curtain is disclosed, comprising a portable curtain having a material to at least partially cover an opening provided in a vehicle's cabin. The personal privacy and protective curtain to at least partially block a passenger from view and provide a protective sanitary barrier during travel. At least one attachment mechanism releasably engages with a surface of at least one fixture within the vehicle cabin to interface with a corresponding attachment mechanism provided on the portable curtain.

### TECHNICAL FIELD

The embodiments generally relate to privacy and protective curtains and, more specifically, relate to privacy and protective curtains that are releasably engaged with cabin fixtures of a vehicle.

### BACKGROUND

Designers of vehicle interiors (e.g., motor vehicles, aircraft, trains, and boats) aim to make a comfortable cabin space which adheres to safety standards. For example, in commercial air travel, cabins are often divided into several parts. These can include travel class sections in medium and large aircraft. Seats are arranged in rows and alleys and may contain passenger entertainment systems or modular chairs to allow the passenger to recline or extend a leg rest for increased comfort.

Travel classes may be divided by curtains to provide the feeling of privacy between business class, first class, and economy class. Depending on the size of the vehicle, it may contain a number of full-flat seats which allow the passenger to lay down during transport. Often, the full-flat seats are provided in a first-class section, or in sections for frequent travelers who have accrued a large amount of travel points, miles, or the like through the travel provider.

On long voyages, many passengers sleep to pass the time or simply to rest during their travel. This experience may be uncomfortable for some as attendants and passengers may pass in a close proximity to the sleeping passenger. While some methods of transportation provide enclosed cabins with doors, window, or the like that shield the passenger from other passengers, most vehicles and methods of transportation do not incorporate such barriers between passengers, and where private cabins are available, as on some trains or planes, fares are typically considerably higher than that for a traditional seat.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

Embodiments described herein provide a personal privacy and protective curtain, comprising a privacy and protective curtain having a material to at least partially cover an opening provided in a vehicle's cabin. The personal privacy and protective curtain is configured to at least partially block a passenger from view and provide a protective sanitary barrier from other passengers during travel. At least one attachment mechanism releasably engages with a surface of at least one fixture within the vehicle cabin to interface with a corresponding attachment mechanism provided on the personal privacy and protective curtain.

The embodiments provide a portable privacy and protective curtain which releasably engages with the fixtures within a vehicle cabin to provide the feeling of security, privacy, and shade from light. The privacy and protective curtain is constructed of a textile which at least partially blocks light while providing a barrier between the passenger and the cabin space such as the alley, adjacent seats, and the like. The device is easily deployable in various cabin shapes and configuration to allow the user to readily deploy and store the device as needed.

In one aspect, the attachment mechanism comprises a first magnet at least partially embedded within a receiver.

In one aspect, a second magnet is attached to a surface of the personal privacy and protective curtain, wherein the second magnet releasably engages with the first magnet.

In one aspect, the attachment mechanism comprises at least one suction cup to releasably engage with the surface.

In one aspect, the suction cup comprises the first magnet at least partially embedded within a receiver.

In one aspect, the attachment mechanism comprises a clip releasably engaged with the surface, wherein the clip retains the personal privacy and protective curtain in a suitable position to at least partially block the passenger from view or provide a protective sanitary barrier.

In one aspect, the clip comprises a first magnet at least partially embedded therein, wherein the magnet releasably engages with a second magnet provided on the personal privacy and protective curtain.

In one aspect, a plurality of magnets are provided within a cavity of the personal privacy and protective curtain.

In one aspect, the plurality of magnets are sewn into the personal privacy and protective curtain to retain the plurality of magnets in a suitable position therein.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of a vehicle cabin and fixtures thereof, according to some embodiments;

FIG. 2 illustrates a perspective view of the personal privacy and protective curtain releasably engaged with one or more fixtures within a vehicle cabin, according to some embodiments;

FIG. 3 illustrates a perspective view of the passenger seated in the vehicle seat, according to some embodiments illustrates a perspective view of the personal privacy and protective curtain releasably engaged with one or more fixtures within a vehicle cabin, according to some embodiments;

FIG. 4 illustrates a perspective view of the personal privacy and protective curtain releasably engaged with one or more fixtures within a vehicle cabin, according to some embodiments;

FIG. 5 illustrates a perspective view of the attachment mechanism releasably engaged with the personal privacy and protective curtain, according to some embodiments;

FIG. 6 illustrates a perspective view of the attachment mechanism releasably engaged with the personal privacy and protective curtain, according to some embodiments; and

FIG. 7 illustrates a cross-section of the personal privacy and protective curtain and magnets disposed therein, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

As used herein, the term “vehicle” may be used to the described motor or engine driven vehicles, cars, busses, trains, aircraft, boats, or other vehicles known in the arts for transporting goods or persons, in addition to similar non-vehicular confined spaces, such as office cubicles, wherein a user may desire additional privacy or protective removable barriers. One skilled in the arts will readily understand that the present system may be utilized with a variety of vehicle types and configurations wherein a user may desire further privacy or protective barriers between themselves and other passengers or areas of the vehicle. Further, the vehicle may correspond to a real-world vehicle or may be configured as an imaginary vehicle which does not exist in the real-world.

In general, the embodiments provided herein relate to a portable privacy and protective curtain which releasably engages with the fixtures within a vehicle cabin. The privacy and protective curtain is constructed of a textile which at least partially blocks light while providing a barrier between the passenger and the cabin space such as the alley, adjacent seats, and the like. The privacy and protective curtain may further be utilized to provide a protective sanitary barrier between the user and other passengers within the vehicle cabin

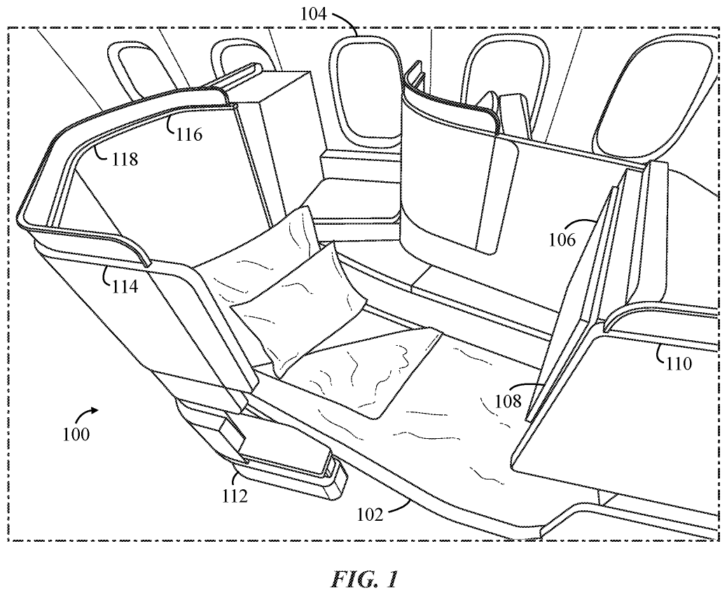

FIG. 1 illustrates a vehicle cabin 100, such as an aircraft cabin, having a seat 102 whereon the passenger sits or lies down during the duration of travel. Often, a window 104 is provided to allow the passenger to view the exterior environment and to provide light during travel. An entertainment system 106 is provided in front of the passenger to allow the passenger to interact with the vehicle's entertainment system. The entertainment system 106 may be provided on the back side 108 of the forward seat 110 positioned in front of the passenger. An armrest 112 is provided which may comprise a folding tray or the like to rest objects or to rest the arms of the passenger during travel. In some embodiments, a sidewall 114 extends from the seatback 116 extending along the headrest 118. Each feature of the vehicle cabin, seat, entertainment system, and sidewalls of the fuselage may be referred to herein as “fixtures” which may provide a means for attaching a personal privacy and protective curtain described herein.

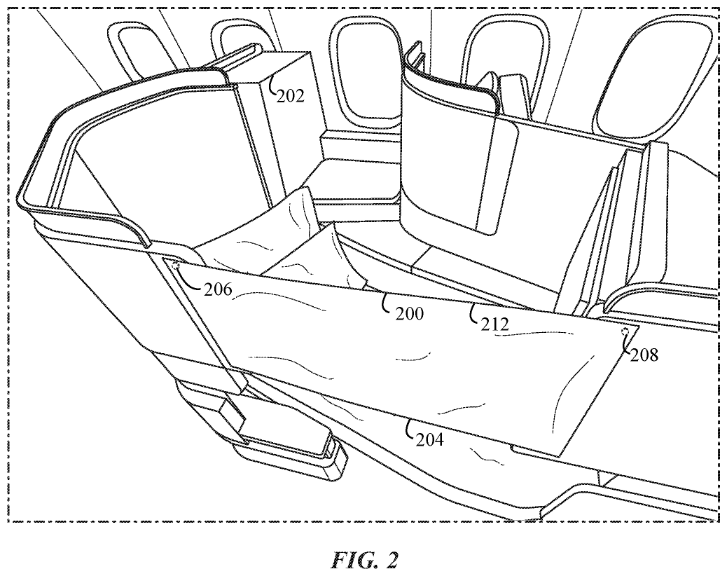

FIG. 2 illustrates the personal privacy and protective curtain 200 releasably engaged with one or more vehicle cabin fixtures 202 within the vehicle cabin space. The personal privacy and protective curtain 200 is dimensioned to extend across the opening 204 defined by the edge of the sidewall 114 and the edge of the back side 108 of the forward seat in front of the passenger. One or more attachment mechanisms 206, 208 are provided to releasably engage with the vehicle cabin fixtures 202. The attachment mechanisms may be interchangeable to allow the personal privacy and protective curtain 200 to selectively interface with various surfaces provided on the fixtures including metals, plastics, windows, textiles, and the like. FIG. 2 specifically shows the personal privacy and protective curtain 200 extending across the entryway to the seat to at least partially block the view of the passenger from the side or provide a protective sanitary barrier between the passenger and other passengers within the vehicle cabin space. The attachment mechanisms 206, 208 are provided on the top portion 212 of the personal privacy and protective curtain 200 to allow the material to extend and hang downward to at least partially block the passenger from view or provide a protective sanitary barrier.

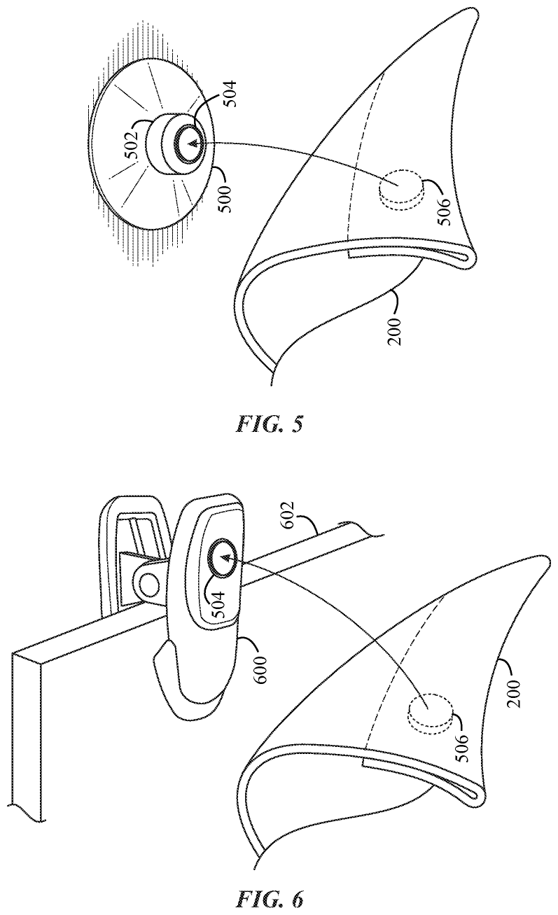

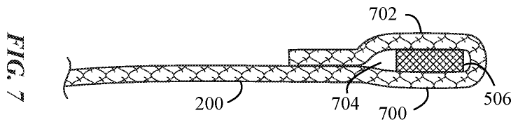

As used herein, the term “attachment mechanism” refers to any means for attaching two or more components such as magnets, hook-and-loop systems, clips, retainers, adhesives, static cling devices, static adhesives, and the like. The attachment mechanism may be at least partially embedded or affixed to a material, such as the material used to construct the personal privacy and protective curtain 200. The attachment mechanism may be provided as a combination of attachment mechanisms, such as those shown in FIG. 5 and FIG. 6 wherein the attachment mechanism comprises a suction cup (shown in FIG. 5) or a clip (shown in FIG. 6), each having an at least partially embedded magnet therein.

In some embodiments, one or more magnets are provided within or on the surface of the personal privacy and protective curtain 200 material. The magnets may be provided in various locations along the perimeter or at the corners of the personal privacy and protective curtain 200. The magnets allow for the personal privacy and protective curtain 200 length, shape, and configuration to be adjusted to fit various dimensions. In some embodiments, the personal privacy and protective curtain 200 may fold onto itself using the magnets to retain the personal privacy and protective curtain 200 in a folded configuration.

In some embodiments, the magnets may be loose within an interior cavity defined by the sidewalls of the personal privacy and protective curtain 200.

In some embodiments, a hook-and-loop system is sewn onto the surface of the personal privacy and protective curtain 200 to interface with a corresponding hook-and-loop system provided on a surface of the attachment mechanism attached to a fixture within the vehicle cabin. For example, a plurality of hook-and-loop systems are provided along the perimeter of the personal privacy and protective curtain 200 to interface with corresponding hook-and-loop systems positioned on the attachment mechanisms.

In some embodiments, the attachment mechanism comprises a rope or string extending through an opening between the first and second sides of the personal privacy and protective curtain 200. The ends of the rope or string may releasably engage with the attachment mechanisms affixed to the fixtures within the vehicle cabin.

One skilled in the arts will readily understand that the personal privacy and protective curtain 200 may be configured either for use with a specific vehicle type or such that it may be universally deployable across several vehicle types such that in some embodiments the personal privacy and protective curtain 200 may be employed within a vehicle cabin 100 of several vehicle types (e.g., motor or engine driven vehicles, cars, busses, trains, aircraft, boats, or other vehicles known in the arts for transporting goods or persons) interchangeably. In some embodiments, the personal privacy and protective curtain 200 may be deployed in non-vehicle settings, such as an office cubicle wherein the user desires further privacy or protectable barrier.

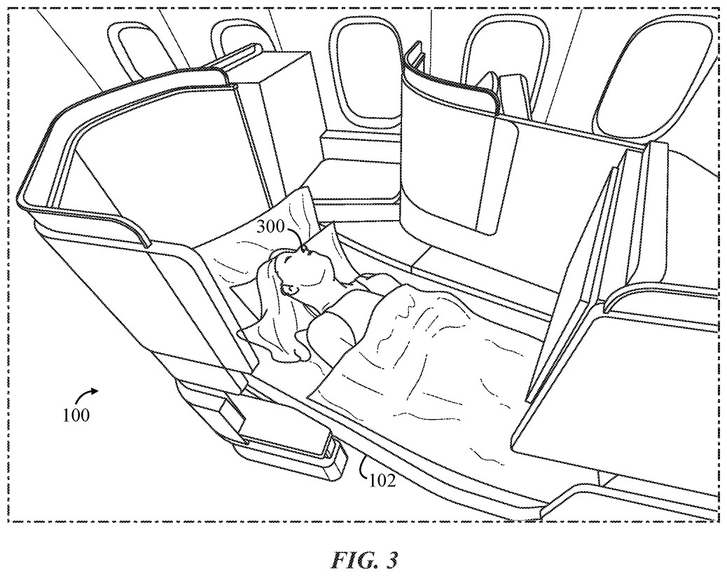

FIG. 3 illustrates the passenger 300 resting on the seat 102 within the vehicle cabin 100. The personal privacy and protective curtain 200 is provided to at least partially cover the passenger, to block the passenger from view from one or more sides, or provide a protective sanitary barrier. The passenger may adjust the orientation of the privacy and protective curtain 200 to suit their liking during travel such that the personal privacy and protective curtain 200 at least partially cover the side and entryway of the seat.

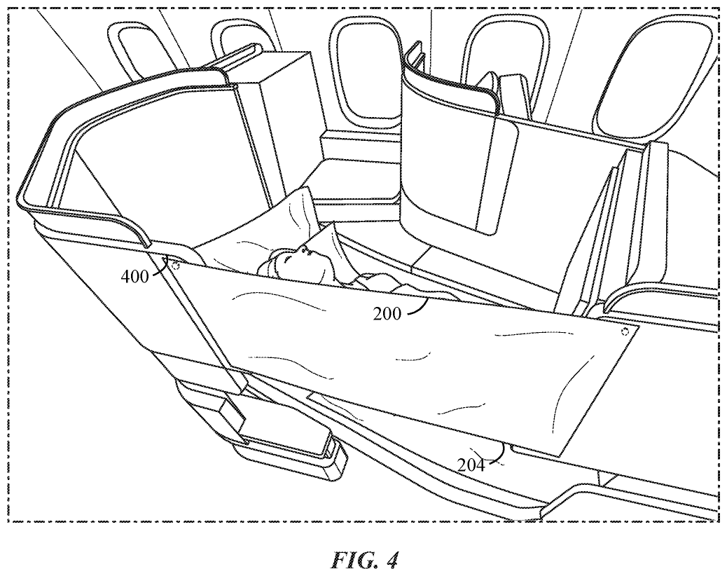

FIG. 4 illustrates the personal privacy and protective curtain 200 extending over the top 400 of the opening 204 to at least partially cover the passenger from the top and/or the sides during travel. The passenger may selectively adjust the orientation of the personal privacy and protective curtain 200 throughout the duration of travel to suit their liking using the releasably engageable attachment mechanisms described herein. One skilled in the art will readily understand that the personal privacy and protective curtain 200 may be configured to extend from the top 400 to extend toward the window of the vehicle cabin to shield the passenger from above.

FIG. 5 illustrates an exemplary attachment mechanism comprising a suction cup 500 having a receiver 502 to receive a magnet 504 or magnetic component to releasably engage with a second magnet 506 or magnetic component provided on the surface of or within the fabric of the personal privacy and protective curtain 200. During use, the suction cup 500 is applied to a surface within the vehicle cabin. The surface may include a window or surface of the seat and components thereof which may provide an anchor for the suction cup. The magnet 504 may be at least partially embedded into the suction cup 500 to provide a smooth interface between the first and second magnets 504, 506.

In some embodiments, an adhesive is provided on a surface of the attachment mechanism to releasably engage with the surface of one or more fixtures provided within the vehicle cabin.

FIG. 6 illustrates an exemplary attachment mechanism comprising a clip 600 to releasably engage with an edge 602 of a fixture within the vehicle cabin. The clip 600 may comprise a magnet 504 or magnetic component to releasably engage with a second magnet provide on the surface of or within the fabric of the personal privacy and protective curtain 200. During use, the clip 600 is first retained on the edge 602 at a suitable distance from a second clip to extend the personal privacy and protective curtain 200 and at least partially block the passenger from view or provide a protective sanitary barrier. The magnet 504 may be at least partially embedded into the suction cup 500 to provide a smooth interface between the first and second magnets 504, 506.

In some embodiments, the personal privacy and protective curtain 200 may be folded over an edge of one or more fixtures 202 to allow the clip 600 to retain the personal privacy and protective curtain 200 thereon. The clip 600 forms a friction fit with the material of the personal privacy and protective curtain 200 to retain the personal privacy and protective curtain 200 in a suitable position to at least partially block the passenger from view from various directions or provide a protective sanitary barrier.

FIG. 7 illustrates a cross-section of the personal privacy and protective curtain 200 comprising a first side 700 and a second side 702 having at least one magnet 506 disposed therebetween. The magnet may be sewn into the cavity 704 between the first and second sides 700, 702 to retain the magnet in a suitable position during use such that the magnet may releasably engage with the attachment mechanism selected by the user.

In some embodiments, the personal privacy and protective curtain 200 may comprise one or more apertures to receive a loop to permit the personal privacy and protective curtain 200 to be hung over at least one fixture 202 within the vehicle cabin. The loop may be formed by a rope, string, or the like having hook-and-loop components on each end to allow the user to selectively form the loop.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A personal privacy and protective curtain, comprising:
a curtain comprising a material to at least partially cover an opening provided in a vehicle cabin, the curtain to at least partially block a passenger from view and provide a protective sanitary barrier;
at least one attachment mechanism to releasably engage with a surface of at least one fixture within the vehicle cabin, the at least one attachment mechanism to interface with a corresponding attachment mechanism provided on the curtain.

2. The personal privacy and protective curtain of claim 1, wherein the attachment mechanism comprises a first magnet at least partially embedded within a receiver.

3. The personal privacy and protective curtain of claim 2, wherein a second magnet is attached to a surface of the curtain, wherein the second magnet releasably engages with the first magnet.

4. The personal privacy and protective curtain of claim 1, wherein the attachment mechanism comprises at least one suction cup to releasably engage with the surface.

5. The personal privacy and protective curtain of claim 4, wherein the suction cup comprises the first magnet at least partially embedded within a receiver.

6. The personal privacy and protective curtain of claim 1, wherein the attachment mechanism comprises a clip releasably engaged with the surface, wherein the clip retains the curtain in a suitable position to at least partially block the passenger from view and provide a protective sanitary barrier.

7. The personal privacy and protective curtain of claim 6, wherein the clip comprises a first magnet at least partially embedded therein, wherein the magnet releasably engages with a second magnet provided on the curtain.

8. The personal privacy and protective curtain of claim 7, wherein a plurality of magnets are provided within a cavity of the curtain.

9. The personal privacy and protective curtain of claim 8, wherein the plurality of magnets are sewn into the curtain to retain the plurality of magnets in a suitable position therein.

10. A personal privacy and protective curtain, comprising:
a portable curtain comprising a material to at least partially cover an opening provided in an vehicle cabin, the portable curtain to at least partially block a passenger from view and provide a protective sanitary barrier, wherein the portable curtain extends from at least a first surface to a second surface of two or more fixtures within the vehicle cabin;
at least one attachment mechanism to releasably engage with a surface of at least one fixture within the vehicle cabin, the at least one attachment mechanism to interface with a corresponding attachment mechanism provided on the portable curtain, the at least one attachment mechanism comprising a flexible material to permit an adjustable fit between the two or more fixtures.

11. The personal privacy and protective curtain of claim 10, wherein the attachment mechanism comprises a first magnet at least partially embedded within a receiver.

12. The personal privacy and protective curtain of claim 11, wherein a second magnet is attached to a surface of the portable curtain, wherein the second magnet releasably engages with the first magnet.

13. The personal privacy and protective curtain of claim 12, wherein the attachment mechanism comprises at least one suction cup to releasably engage with the surface.

14. The personal privacy and protective curtain of claim 13, wherein the suction cup comprises the first magnet at least partially embedded within a receiver.

15. The personal privacy and protective curtain of claim 14, wherein the attachment mechanism comprises a clip releasably engaged with the surface, wherein the clip retains the portable curtain in a suitable position to at least partially block the passenger from view and provide a protective sanitary barrier.

16. The personal privacy and protective curtain of claim 15, wherein the clip comprises a first magnet at least partially embedded therein, wherein the magnet releasably engages with a second magnet provided on the portable curtain.

17. The personal privacy and protective curtain of claim 16, wherein a plurality of magnets are provided within a cavity of the portable curtain.

18. The personal privacy and protective curtain of claim 17, wherein the plurality of magnets are sewn into the portable curtain to retain the plurality of magnets in a suitable position therein.

19. The personal privacy and protective curtain of claim 18, wherein the attachment mechanism is a hook-and-loop system to permit the portable curtain to releasably engage with the two or more fixtures.

20. A personal privacy and protective curtain, comprising:
a portable curtain comprising a material to at least partially cover an opening provided in an vehicle cabin, the portable curtain to at least partially block a passenger from view and provide a protective sanitary barrier, wherein the portable curtain extends from at least a first surface to a second surface of two or more fixtures within the vehicle cabin;
at least one attachment mechanism to releasably engage with a surface of at least one fixture within the vehicle cabin, the at least one attachment mechanism to interface with a corresponding attachment mechanism provided on the portable curtain, the at least one attachment mechanism comprising a flexible material to permit an adjustable fit between the two or more fixtures, the at least one attachment mechanism comprises at least one of the following: at least one magnet and corresponding magnet to releasably engage the portable curtain to the two or more fixtures, at least one hook-and-loop system to releasably engage the portable curtain to the two or more fixtures, at least one rope extending through an opening of the portable curtain to releasably engage the portable curtain to the two or more fixtures, and at least one clip to releasably engage the portable curtain to the two or more fixtures.
